(19) United States
(12) Patent Application Publication
(10) Pub. No.: US 2008/0263621 A1
(43) Pub. Date: Oct. 23, 2008

(54) Set top box with transcoding capabilities

(75) Inventors: Ofer Austerlitz, Tel-Mond (IL); Amir Morad, Tel-Aviv (IL); Leonid Yavits, Herzlia (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/785,397

(22) Filed: Apr. 17, 2007

(51) Int. Cl. H04N 7/16

(52) U.S. Cl. 725/139

(57) ABSTRACT

A media stream transcoding set top box including an RF input interface, an RF receiver configured to receive from the RF input interface an RF signal including an original digital media stream, and produce an input digital media stream based, at least in part, on the original digital media stream, the input digital media stream including one or more channels, the channels carrying at least one media stream, a decoder configured to receive the input digital media stream and extract therefrom an uncompressed media stream, a processor configured to process the uncompressed media stream, to produce a processed media stream, an encoder configured to compress the processed media stream, to produce a compressed processed digital media stream, and an output interface configured to output the compressed processed digital media stream in a format suitable for a client device. Related apparatus and methods are also described.

### FIELD OF THE INVENTION

The present invention relates to communication systems and, more particularly but not exclusively, to set top boxes for receiving media streams, transcoding media streams, and transmitting the transcoded media streams for storage on storage units and for display on display units.

### BACKGROUND OF THE INVENTION

Digital set top boxes (STBs) are often used to receive television broadcast of multiple compressed video channels, through terrestrial, cable, and satellite links, and to provide an output for display at a television display. The set top box demodulates, decrypts, and decodes received television signals, and can typically also compose several channels into one composite screen. Composing may be performed with internally generated graphics to provide a display showing various channels as small screens with the internally generated graphics filling the spaces in between. The small screens may also be combined with information, such as an Electronic Program Guide (EPG). The set top box provides the composite screen as a single video channel to the television display.

Usually, the incoming video signal is encrypted, in order to prevent viewing without payment. One of the more significant tasks of the set top box is to decrypt the encrypted signal.

Some digital television sets include some set top box components, and are able to perform tasks of a simple set top box, such as deciphering and decoding one or two channels of a multiplexed compressed stream. Such digital television sets may have two input interfaces. A first input interface is a compressed data interface which receives video data encoded in accordance with a certain standard, for example, an MPEG-2, and which typically receives data from a terrestrial or cable link. A second input interface is a raw data interface through which uncompressed data is received from an external set top box or some other electronic appliance, such as a DVD player or a Video Cassette player.

Some set top boxes provide advanced services. For example, some set top boxes are designed to allow an arranging of data which originates from a number of content sources for display on a television display. The content sources typically include a television channel stream, but may additionally incorporate e-mail, graphics, gaming, EPG, World Wide Web pages, and so on. Such a set top box generally receives data separately from each content source, and arranges the received data into a single composite output stream for display on the television display.

Some set top boxes include a large memory unit, typically a hard disk, used for storing data received from the different content sources. The memory unit enables users to time their access to stored data, such as recorded content of a television channel. The memory unit further allows the users to view the stored data in trick play modes, such as fast forward, fast backward, and slow motion. In addition, users can typically access data from the memory unit at the same time as storing content from another source. Some set top boxes include additional functionality such as gaming and embedded Consumer Electronic (CE) appliances such as a DVD recorder.

Many households have a number of television sets which are used simultaneously. Normally, each television requires a separate set top box. Households can have a mix of one or more advanced set top boxes, with extended features as described above, with additional simple, basic, cheaper, set top boxes, sometimes termed “zapper” set top boxes. The zapper set top boxes are without many of the advanced services.

Portable media players, and other portable devices such as iPODs, mobile phones, laptops, and so on, which enable media playback, are becoming increasingly common. Content sharing and transferring between several different devices, for example a set top box and a portable device, is expected to become widespread. Such sharing presents numerous technical and legal issues. One desired feature of content sharing is retention of content protection. Another desired feature is content format transformation. An inability to efficiently transfer live TV content to a portable media player has becomes an annoying problem.

An advanced codec which is referred to within the present disclosure is described in U.S. patent application Ser. No. 11/603,199 of Morad et al, the disclosure of which is hereby incorporated herein by reference.

U.S. Pat. No. 6,263,503 to Margulis is believed to represent the state of the art with reference to wireless television systems.

There is thus a widely recognized need for, and it would be highly advantageous to have, a set top box devoid of the above limitations, which would allow simultaneous video distribution to a number of destinations inside and outside a customer's home, as well as efficient formatting and transferring of video, audio, and other media to and from CE devices such as portable media players.

The disclosures of all references mentioned above and throughout the present specification, as well as the disclosures of all references mentioned in those references, are hereby incorporated herein by reference.

### SUMMARY OF THE INVENTION

The present invention seeks to provide an improved set top box and method of transcoding, to enable simultaneous video distribution to a number of destinations and devices. The improved set top box seeks to encode video in formats appropriate for distribution via distribution paths found in home networks, appropriate for storage in media storage devices found in homes, and appropriate for display by consumer displays found in homes and in private use.

The appropriate formats are efficiently formatted, taking into account bandwidth of the distribution paths and computing power available at the consumer displays.

The improved set top box typically provide transcoding services, in that the improved set top box typically decodes video signals and re-encodes the video signals as described above.

According to one aspect of the present invention there is provided a media stream transcoding set top box (STB) including an RF input interface, an RF receiver configured to receive from the RF input interface an RF signal including an original digital media stream, and produce an input digital media stream based, at least in part, on the original digital media stream, the input digital media stream including one or more channels, the channels carrying at least one media stream, a decoder configured to receive the input digital media stream and extract therefrom an uncompressed media stream, a processor configured to process the uncompressed media stream, to produce a processed media stream, an encoder configured to compress the processed media stream, to produce a compressed processed digital media stream, and an output interface configured to output the compressed processed digital media stream in a format suitable for a client device.

According to another aspect of the present invention there is provided a method of transcoding a media stream including receiving an RF signal including an original digital media stream, producing an input digital media stream based, at least in part, on the original digital media stream, the input digital media stream including one or more channels, the channels carrying at least one media stream, extracting an uncompressed media stream from the input digital media stream, processing the uncompressed media stream, producing a processed media stream, and compressing the processed media stream, producing a compressed processed digital media stream, and outputting the compressed processed digital media stream in a format suitable for a client device.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified illustration of a functional relationship among components of a transcoder set top box constructed and operative in accordance with a preferred embodiment of the present invention;

FIG. 1B is a simplified block diagram illustration of the transcoder set top box of FIG. 1A;

FIG. 2 is a simplified block diagram illustration of the transcoder set top box of FIG. 1B being used in a first typical configuration;

FIG. 3 is a simplified block diagram illustration of the transcoder set top box of FIG. 1B being used in a second typical configuration;

FIG. 4 is a simplified block diagram illustration of the transcoder set top box of FIG. 1B being used in a third typical configuration;

FIG. 5 is a simplified block diagram illustration of internal units within the transcoder set top box of FIG. 1B, arranged for better understanding of the transcoder set top box being used in the third typical configuration;

FIG. 6 is a simplified block diagram illustration of an alternative preferred embodiment of the present invention, based on an advanced media codec, being used in a fourth typical configuration; and

FIG. 7 is a simplified flowchart illustration of a preferred method of operation of the system of FIG. 1A.

### DESCRIPTION OF PREFERRED EMBODIMENTS

The present embodiments comprise an apparatus and methods for a transcoder set top box (STB), adding functions to standard set top box functions.

The transcoder set top box is configured to simultaneously receive media streams via any of a plurality of inputs, decodes the media streams, transcodes the media streams into formats suitable for many media devices, and outputs the media streams to the media devices. The transcoder set top box preferably maintains Digital Rights Management (DRM) and copy protection properties of the media streams. The transcoder set top box offers functionality not available elsewhere in a single package.

The transcoder set top box is configured to simultaneously receive media streams from external sources via any of a plurality of inputs, such as, by way of a non-limiting example, RF inputs from satellite, cable and digital terrestrial feeds, analog inputs, and digital inputs. The inputs can also be, by way of a non-limiting example, from Consumer Electronic (CE) appliances such as DVDs, camcorders, digital cameras, mobile phones, and from the World Wide Web.

The inputs are by various connections, such as, by way of a non-limiting example, by cable, by wire, and wireless.

The transcoder set top box demodulates, decrypts, and decodes the received media streams. The transcoder set top box provides a function of transcoding the received media streams by processing and re-encoding the received media streams. In processing and re-encoding the media streams, the transcoder set top box takes into account by what distribution path the media streams are distributed, and to which client device the media streams are distributed.

The distribution paths supported by the transcoder set top box include, by way of a non-limiting example, wire, optic fiber, wireless, home network, and remote network such as the World Wide Web.

In a preferred embodiment of the present invention, the transcoder set top box is configured to transmit media streams to a remote location, within or outside a user's home, via a home network, a local area network, the internet, the World Wide Web, and any other computer network. The transmission to a remote location is termed “place shifting”.

The client devices include a variety of audio-visual devices, typically used for displaying video, sounding audio, and storing audio-visual content, as well as devices which are less typically used for the above uses, but enable such use. The client devices include, by way of a non-limiting example, display devices such as: remote computers; TV sets; TV displays as part of wireless TV system, also termed “location free TV” or “two piece TV”; remote set top boxes; mobile phones; MP3 players; Portable Media Players (PMPs); iPods; video pods; and MP4 players.

The transcoder set top box re-encodes video in formats suitable for distribution via the distribution paths and suitable for storage in the media storage devices.

The above-mentioned formats are efficiently formatted, taking into account bandwidth of the distribution path and computing power available at the client devices for processing and displaying the media streams.

The media streams can optionally be scaled, changing resolution of the video frames comprised in the media streams, thereby changing format of the media streams from a received format to a different format suitable for a specific distribution bandwidth and for a specific display.

The distributed media streams are preferably compressed before distribution.

The distributed media streams are preferably encrypted before distribution.

Several received media streams may be decoded and combined together with graphics and data objects, such as, by way of a non-limiting example, internet pages, menus, an EPG, still images, and video gaming, thereby forming a composite layout stream. A plurality of video, graphics, data streams and composite layout streams can be simultaneously transmitted to more than one client device.

In a preferred embodiment of the present invention the transmitted streams are formatted for display by the client devices without requiring substantial processing by the client devices.

The transmitted media streams can be transmitted simultaneously either directly to the TV displays or via a simplified thin-client set top box which decodes the received transmitted stream without rearranging the layout of the transmitted stream.

The transcoder set top box is preferably housed in a single housing which can be positioned at a distance from client set top boxes and remote TV displays.

In a preferred embodiment of the present invention, the transcoder set top box produces output enabling advanced video functions, such as, by way of a non-limiting example, interactive video applications, Electronic Program Guides, and so on.

In a typical, non-limiting example, application involving an interactive video application, the transcoder set top box produces an encoded transport stream which comprises video and audio to be displayed by a remote set top box or television, and when a user interacts with the interactive video application, the interaction is via a remote control which communicates with the transcoder set top box rather than with the remote set top box or television. Persons skilled in the art will appreciate that UHF remote controls are available which provide a range of communication which can extend, by way of a non-limiting example, from one room to another room in a home.

In a preferred embodiment of the present invention, substantially most of the transcoder set top box electronic functionality is implemented on a single silicon die.

It is to be appreciated that a media stream is to be understood as any of a wide interpretation of the term media stream, such as, by way of a non-limiting example, a video channel, a program channel, a composite of several video streams, a composite of several video and audio streams, a composite of several video streams depicting a common object from different angles, a video stream associated with one or more audio streams, a video stream associated with dubbing streams in different languages, a subtitle stream, an analog video stream, a digital video stream, graphic planes and streams, web pages, streams comprising a composite of graphics and video, graphics and audio, an electronic program guide (EPG) stream, and transport streams according to various transport stream protocols.

The term “AV” in all its forms is used throughout the present specification and claims interchangeably with the terms “AV stream”, “audio visual”, “audio visual stream”, “video”, “video stream”, “audio”, “audio stream”, “media”, “media stream”, “transport stream”, “TV signal”, “video signal”, and their corresponding forms.

The term “encoding” in all its forms is used throughout the present specification and claims interchangeably with the term “compressing” and its corresponding forms.

The principles and operation of an apparatus and methods for a transcoder set top box according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

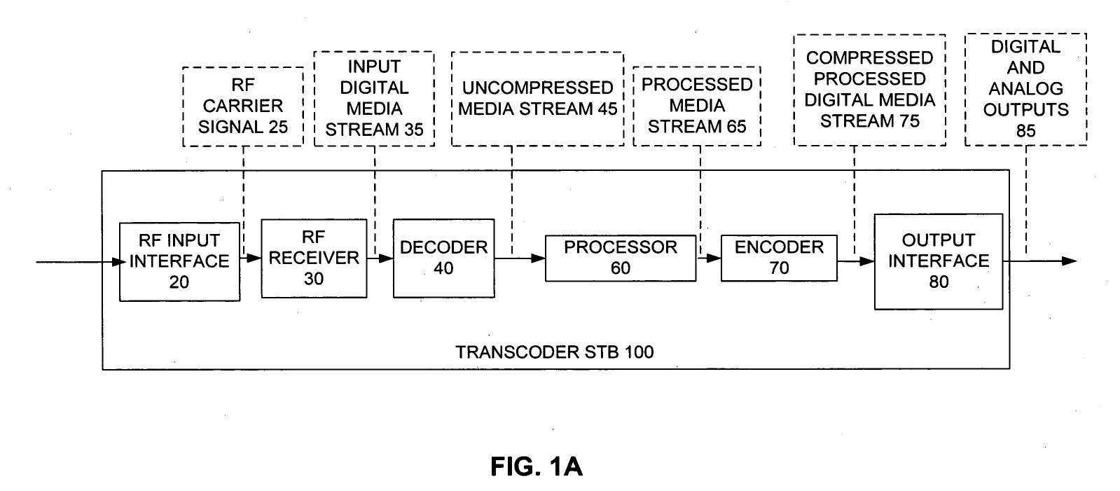

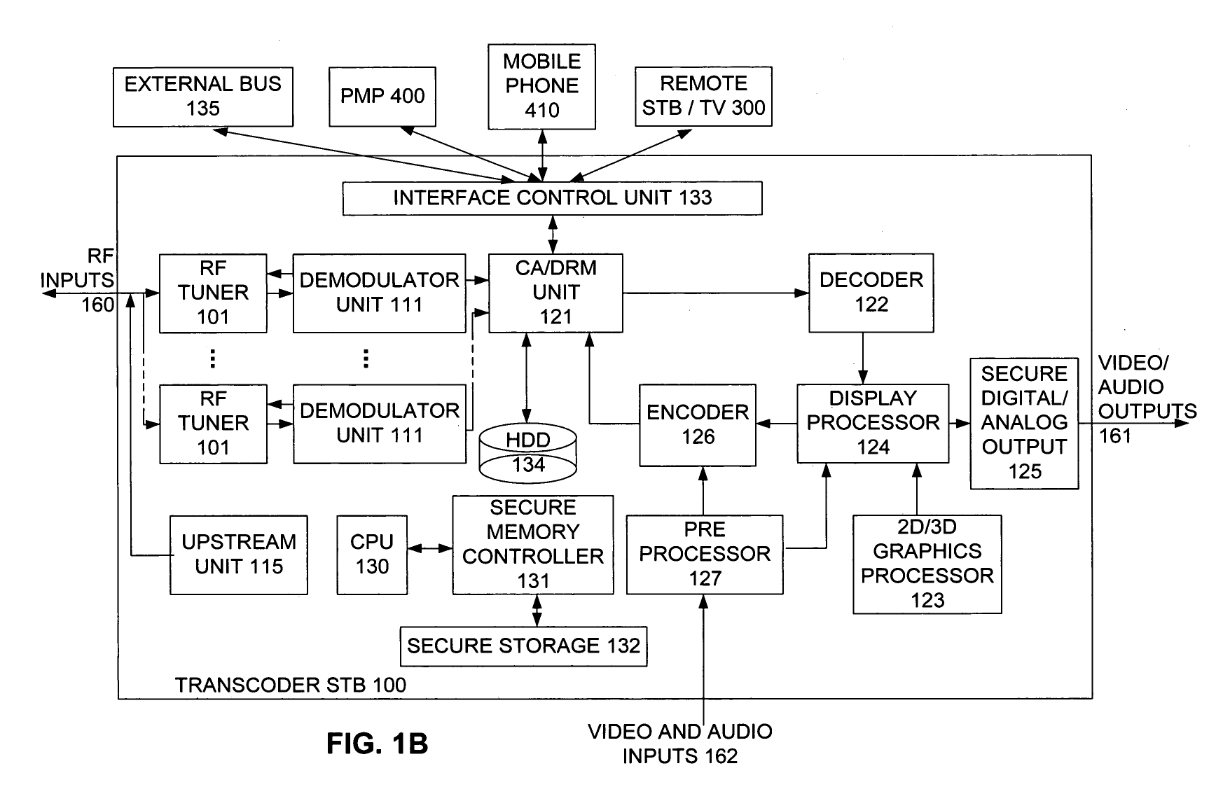

Reference is now made to FIG. 1A, which is a simplified illustration of a functional relationship among components of a transcoder set top box 100 constructed and operative in accordance with a preferred embodiment of the present invention.

The transcoder set top box 100 comprises one or more RF input interfaces 20, connected to an RF receiver 30, which is connected to a decoder 40, which is connected to a processor 60, which is connected to an encoder 70, which is connected to one or more output interfaces 80.

The transcoder set top box 100 generally operates as a device for receiving media streams, typically multiplexed and compressed media streams, decoding the media streams and extracting specific uncompressed media streams comprised within the input multiplexed and compressed media streams. The transcoder set top box 100 typically further encodes the specific uncompressed media streams into a format suitable for a variety of client devices, such as, by way of a non-limiting example, remote set top boxes, remote television sets and wireless television displays, as well as Portable Media Players, mobile phones, and external storage devices.

The transcoder set top box 100 accepts input of an RF signal 25 comprising a digital media stream, via the RF input interface 20, uses the RF receiver 30 to produce an input digital media stream 35, and the decoder 40 to demultiplex, decipher, and decode one or more of the specific uncompressed media streams 45 from the input digital media stream 35.

It is to be appreciated that the transcoder set top box 100 is also configured to accept input of specific uncompressed media streams 45 from one or more video and audio inputs (not shown) directly into the processor 60.

The specific uncompressed media streams 45 are typically processed by the processor 60, and processed media streams 65 are output from the processor 60 into the encoder 70. The encoder 70 encodes the output of the processor 60 and generally produces an encoded processed digital media stream 75.

It is to be appreciated that the transcoder set top box 100 is also configured to connect the processor 60 to the one or more output interfaces 80, to output the processed media stream 65.

It is to be appreciated that the transcoder set top box 100 is also configured to connect the decoder 40 to the one or more output interfaces 80, to output the uncompressed media stream 45.

The decoding of the media streams and subsequent processing and encoding typically comprise the transcoding.

The one or more output interfaces 80 receive the output of the encoder 70 as input, and transmit the output to client devices connected to the transcoder set top box 100.

It is to be appreciated that the transcoder set top box may output media streams not only to client devices, such as remote set top boxes, remote television sets and wireless television displays, as well as Portable Media Players, mobile phones and external storage devices, but also to local display and sound devices such as a TV set.

In an alternative preferred embodiment of the present invention, the one or more output interfaces 80 are also preferably connected to the processor 60, and configured to output the processed media stream 65 without compression.

In another alternative preferred embodiment of the present invention, the one or more output interfaces 80 are also preferably connected to the decoder 40, and configured to output the uncompressed media stream 45.

It is to be appreciated that the components of the transcoder set top box 100 described above with reference to FIG. 1A are a general reference to functional units which are comprised of sub-units. The functional units and sub-units are described in further detail below with reference to FIG. 1B.

Reference is now made to FIG. 1B, which is a simplified block diagram illustration of the transcoder set top box 100 of FIG. 1A.

The transcoder set top box 100 comprises one or more RF tuners 101, one or more demodulator units 111, and an upstream unit 115. The transcoder set top box 100 further comprises a conditional access and digital rights management (CA/DRM) unit 121, a decoder 122, a 2D/3D graphics processor 123, a display processor 124, a secure digital and analog output 125, an encoder 126, a pre-processor 127, a CPU 130, a secure memory controller 131, a secure storage 132, an interface control unit 133, a hard disk 134, one or more RF inputs 160, one or more video and audio outputs 161, and one or more video and audio inputs 162.

External units are depicted as connected to the transcoder set top box 100, via the interface control unit 133. The external units are an external bus 135, one or more Portable Media Players (PMPs) 400, one or more mobile phones 410, and one or more remote client STB and TV sets 300. It is to be appreciated that one of each of the external units is depicted in FIG. 1B, but that more than one of each can be connected to the transcoder set top box 100 via the interface control unit 133.

It is to be appreciated that the above-listed components are connected as depicted in FIG. 1B, but that not all connections are depicted. Drawing all the connections would make FIG. 1B confusing. By way of a non-limiting example, it is to be appreciated that the CPU 130 is connected to most of the above-listed components, and that the secure memory controller 131 is connected to most of the above-listed components. Connections necessary for understanding preferred embodiments of the present invention are further described below with reference to a more detailed description of the components.

Further description of the above-listed components is provided below.

The RF tuner 101 downconverts an RF input frequency of an RF input signal from an RF carrier frequency, to a lower intermediate frequency, which can be digitized and processed by the demodulator unit 111. The RF tuner 101 supports both single-channel and multi-channel tuning.

The RF tuner 101 comprises several components, such as, and without limiting the generality of the foregoing, a frequency synthesizer, and a variable gain amplifier. The RF tuner 101 is preferably designed to receive a feedback gain signal from the demodulator unit 111.

The RF tuner 101 is preferably manufactured using an RF Complementary Metal Oxide Semiconductor (CMOS) manufacturing process.

The RF input signals are fed to the RF tuners 101 through the RF inputs 160. The output of the RF tuners 101 is fed to the demodulator units 111.

The demodulator units 111 receive an intermediate, also termed baseband, frequency signal from the RF tuners 101, and retrieve compressed digital media streams.

The demodulator units 111 comprise several components, such as, and without limiting the generality of the foregoing, an analog to digital converter, a DC compensation unit, an automatic gain control (AGC), a timing recovery unit, a matched filter, an equalizer, a synchronizer, and a Forward Error Correction (FEC) unit. The AGC provides gain control feedback signals to the RF tuners 101. The output of the demodulator units 111 is fed to the CA/DRM unit 121.

The upstream unit 115 provides two functions. A first function is a back-channel, or upstream communication. A second function is sending control signals to a satellite dish.

In a preferred embodiment of the present invention, which comprises a cable set top box, the upstream unit 115 provides back channel communication with the cable service provider. The upstream unit 115 complies with the Data Over Cable Service Interface Specification (DOCSIS) Set-top Gateway (or DSG) standard, and transmits DOCSIS signals and other auxiliary digital information through an RF interface connected to the RF input 160.

In an alternative preferred embodiment of the present invention, the upstream unit 115 complies with other communication standards for back channel communication.

In yet another preferred embodiment of the present invention, which comprises a satellite set top box, the upstream unit 115 is communicates with the satellite dish by transmitting a control signal, according to a communication protocol, through the RF input 160, and over an RF cable (not shown) leading from the set top box to the satellite dish. The communication protocol includes, without limiting the generality of the foregoing, Frequency Shift Keying (FSK), Amplitude Shift Keying (ASK), Phase Shift Keying (PSK), Pulse Width Modulation (PWM), and a Digital Satellite Equipment Control (DiSEqC) protocol.

The upstream unit 115 preferably supports DiSEqC European Telecommunications Satellite organization (EUTELSAT) Encoding, External Modulation Input, and DiSEqC 2.2 support.

The upstream unit 115 preferably comprises a built in tone oscillator, factory trimmed to 22 kHz.

In addition to DiSEqC protocol, the upstream unit 115 is configurable to support additional communication protocols using various modulation methods, such as, by way of a non-limiting example, QAM (Quadrature Amplitude Modulation), PSK, FSK. By way of a non-limiting example, FSK modulation can be FSK modulation over a 2.3 MHz carrier frequency, as is typically used in DirecTV FTM systems.

In yet another preferred embodiment of the present invention, the upstream unit 115 communicates with a service provider using modem signals over a plain telephone line, an xDSL modem connection.

The CA/DRM Unit 121 decrypts compressed media streams according to a variety of decryption algorithms and transfers the decrypted streams to the decoder 122.

The CA/DRM Unit 121 decrypts the encrypted compressed streams according to one or more encryption algorithms, and in accordance with a variety of security, CA, copy protection and DRM schemes. It is to be appreciated that any of numerous decryption algorithms and ciphers such as, by way of a non-limiting example, CSS, AACS, AES, DES, RC4, RSA, ECC, and others can be used to decrypt the streams. The encryption algorithms are well known in the art and, hence, will not be described here in detail.

Preferably, the CA/DRM Unit 121 generates and maintains a plurality of distinct authentication keys, such as, by way of a non-limiting example, keys to be used exclusively by the Secure Memory Controller 131. Such keys are preferably not kept constant, and depend upon information kept on a secure one time programmable (OTP) memory, upon additional information taken from external removable security devices such as smart cards, upon yet other information preferably taken from an embedded true random number generator (not shown in FIG. 1B), and upon additional similar information.

An additional security element preferably comprised in the CA/DRM Unit 121 is a Downloadable Conditional Access System (DCAS), which defines a standard for secure download of a specific Conditional Access scheme to an Open Cable Application Platform (OCAP) compliant consumer media device. The DCAS scheme is not limited to OCAP, and can be found in other applications, such as IPTV, DTV, and so on.

The CA/DRM Unit 121 preferably contains a secure OTP, a secure processor, a true random number generator, various ciphers, and hardware based processors for generating and exchanging secure CA/DRM keys with external security equipment and devices. The external security equipment and devices can be, by way of a non-limiting example, a smart card, a cable card, IEEE1394 DTCP (Digital Transmission Content Protection) based equipment, and so on.

A secure processor is preferably used to generate authentication keys, used in cases where the media streams are encrypted by the transcoder set top box 100, and to provide secure communication with the HDD 134, with the interface control unit 133, with the secure storage unit 132, with the copy protected audio/video output 161 and the like. The authentication keys are preferably generated and transferred to the applicable processors directly, and without additional intervention of intervening processors, such as, by way of a non-limiting example, the CPU 130. The authentication keys are preferably stored in non-accessible sections of the above-mentioned units. By way of a non-limiting example, the authentication keys are preferably stored in write-only registers of the secure memory controller 131, with an aim of preventing any access, disassembling, hacking or otherwise. Preferably, the authentication keys are never exported or stored outside transcoder set top box 100.

In a preferred embodiment of the present invention, the CA/DRM unit 121 also provides encryption. The CA/DRM unit 121 encrypts media streams, according to an encryption algorithm, and in accordance with a variety of CA/DRM schemes. It is to be appreciated that any of numerous ciphering algorithms, such as, by way of a non-limiting example, CSS, AACS, AES, DES, RC4, RSA, ECC, and others can be used to encrypt the media streams. The encrypted media streams can be also super-encrypted by applying more than one ciphering algorithm to the same stream.

The CA/DRM unit 121 transmits the encrypted media streams to a variety of suitable destinations. A suitable destination can be, by way of a non-limiting example, the hard disk 134, the Portable Media Player (PMP) 400 via the interface control unit 133, the remote client STB and TV set 300 via the interface control unit 133, and an external storage unit 500 (not shown) via the interface control unit 133 and via the external bus 135. In a preferred embodiment of the present invention, the external bus is an external SATA (eSATA) bus.

The decoder 122 receives the decrypted media streams from the CA/DRM Unit 121, demultiplexes the decrypted media streams into separate video, audio and data bitstreams, further decodes the video and the audio streams in accordance with suitable compression standards, and produces reconstructed video and audio signals.

The decoder 122 comprises several components, such as, and without limiting the generality of the foregoing, a de-multiplexer, a video decoding processor, and an audio decoding processor.

The de-multiplexer preferably receives the decrypted media streams from the CA/DRM unit 121 and de-multiplexes the media streams, thereby generating separate video, audio, still image, and auxiliary data streams. The decrypted media streams received from the CA/DRM unit 121 are usually compressed, and in such cases the generated separate video, audio, still image, and auxiliary data streams are also compressed. The de-multiplexer preferably identifies which compression method was used to compress the media streams and provides information about the compression method to other units of the decoder 122.

It is to be appreciated that the de-multiplexer filters some media streams, in parallel, and separates out only specific parts of the streams. By way of a non-limiting example, the specific parts can be certain programs picked out of a complete transport stream.

In a preferred embodiment of the present invention the de-multiplexed streams are preferably indexed in a manner which enables implementation of trick mode plays, such as fast forward, fast backward, and so on.

The de-multiplexed streams are transferred, preferably after re-encrypting, to the hard disk 134 for storage. The stored de-multiplexed streams are typically eventually decrypted, decompressed, and played back, or streamed to a remote TV display or set top box.

In an alternative preferred embodiment of the present invention, the de-multiplexing and processing of the media stream, including indexing, trick play and personal video recording processing is performed by the CA/DRM unit 121. The CA/DRM unit 121 transfers separate video, audio, and still image streams to the decoder 122, which performs decoding of the video, audio and still image streams.

The decoder 122 decodes compressed video, thereby restoring a video signal. The decoder 122 is preferably configured to perform decoding suitable for the compression algorithm by which the media stream was compressed, and additionally suited for removing compression artifacts.

The decoder 122 is preferably capable of decoding video encoded using MPEG1, MPEG2, MPEG4, AVC, VC-1, AVS and other video compression standards known in the art.

The decoder 122 is preferably configured to perform a wide range of decoding operations, such as, by way of a non-limiting example, context-adaptive binary arithmetic coding (CABAC), context-adaptive variable-length coding (CAVLC), variable length decoding, inverse quantization, DC/AC prediction, inverse spatial transformation, motion compensation, de-blocking filtering, and de-ringing filtering

The restored video signal produced by the decoder 122 is transferred to the display processor 124.

In a preferred embodiment of the present invention, the decoder 122 decodes compressed audio, thereby restoring an audio signal. The restored audio signal is transferred to the display processor 124. The decoder 122 is preferably configured to decode compressed audio encoded using MPEG1 Layer 1, 2, 3, AC-3 (now known as Dolby Digital), Dolby Digital, Dolby Digital plus, AAC (Advanced Audio Coding), DTS (Digital Theater System), DTS+, WMA (Windows Media Audio), WMA Pro, and other audio compression standards known in the art.

The 2D/3D graphics processor 123 generates graphics planes based on control signals. The control signals are typically received from the decoder 122, from the CPU 130, and from an external controller connected to the external bus 135. The 2D/3D graphics processor 123 combines, also termed blends, a part or all of the graphics planes. The graphics planes are transmitted to the display processor 124.

The display processor 124 performs multi-stream video post-processing and display processing operations. The video post-processing and display processing operations include, by way of a non-limiting example, de-blocking, de-ringing, noise reduction, edge enhancement, picture scaling, de-blurring, moiré cancellation, de-interlacing, inverse 3:2 and 2:2 pull-down, frame rate conversion, frame interpolation, false contour removal, and any combination thereof, as well as blending of multi-plane multi-stream video, data such as HTML, still images, and graphics.

The display processor 124 preferably transfers processed video signals to the secure digital and analog output 125.

In a preferred embodiment of the present invention, the display processor 124 also performs post-processing of audio sequences such as, by way of a non-limiting example, audio enhancement, audio effects, multi-stream audio blending, and audio watermarking. The display processor 124 preferably transfers the post-processed audio signals to the secure digital and analog output 125.

In an alternative preferred embodiment of the present invention, all audio processing activities are performed by an audio decoding portion of the decoder 122, and the audio signal passes directly (not shown) to the secure digital and analog output module 125.

In a preferred embodiment of the present invention, video and audio signals are transferred from an external video source, via the video and audio inputs 162, through the pre-processor 127, to the display processor 124. The display processor 124 produces a composite video signal by blending graphics planes generated by the 2D/3D graphics processor 123 with pre-processed uncompressed video signals received from the external video source. The display processor 124 preferably adds other planes, such as, by way of a non-limiting example, decoded video streams, to the composite video signal. The composite video signal is then transferred to the secure digital and analog output 125.

It is to be appreciated that if the video signal from the external video source comprises interlaced video, the display processor 124 preferably de-interlaces the video signal.

In yet another preferred embodiment of the present invention, the display processor 124 creates a sequence of composite layout frames which are subsequently transferred to the secure digital and analog output 125.

In another preferred embodiment of the present invention, the display processor 124 transfers the composite video frames to the encoder 126, for further encoding as will be further described below.

The secure digital and analog output 125 receives a plurality of media streams, such as, by way of a non-limiting example, composite layout streams, video streams, and audio streams from the display processor 124, and outputs the media streams in digital form. By way of a non-limiting example, the digital form is suitable for HDMI, or for DisplayPort. The secure digital and analog output 125 is also capable of converting the media streams to analog form, and of outputting the media streams in analog form. By way of a non-limiting example, analog form can be s-video (YC), composite video (CVBS), and component (YCbCr, RGB) video formats as are well known in the art, and a combination thereof.

In a preferred embodiment of the present invention, the secure digital and analog output 125 also inserts horizontal blanking interval (HBI) and vertical blanking interval (VBI) signals into the output video.

The secure digital and analog output module 125 preferably implements one or more copy protection schemes. By way of a non-limiting example, copy protection for digital video and audio streams is implemented by a copy protection scheme such as HDCP™ for HDMI. For analog video streams, copy protection schemes such as, by way of a non-limiting example, Macrovision™ and Dwight Cavendish System (DCS) are implemented. For analog audio streams, a copy protection scheme such as, by way of a non-limiting example, Verance audio watermarking is implemented.

It is to be appreciated that any other copy protection scheme which can prevent unauthorized access or illegitimate usage may also be implemented.

The video and audio signals in digital or analog copy-protected form are transferred to an external local TV, display, or sound system through the one or more video and audio outputs 161.

The encoder 126 receives uncompressed video and audio streams from the display processor 124, encodes video and audio in accordance with certain encoding and compression standards, and multiplexes the resulting compressed video and audio bit-streams into transport streams. The encoder 126 comprises several components, such as, and without limiting the generality of the foregoing, a video encoding unit (not shown), an audio encoding unit (not shown), and a multiplexer (not shown).

The video encoding unit (not shown) encodes uncompressed video and generates a video bit-stream. The video encoding unit comprises several sub-components, such as, and without limiting the generality of the foregoing, a video preprocessing sub-component, a motion estimation sub-component, an intra prediction sub-component, an inter prediction sub-component, a spatial transformation sub-component, a quantization sub-component, a DC/AC prediction sub-component, a rate/distortion optimization sub-component, a rate control sub-component, an entropy encoding sub-component, and a bit-stream formatting sub-component. Video preprocessing cleans the uncompressed video and minimizes noise and artifacts contained in the video, in order to optimize encoding efficiency. Motion estimation and inter prediction track motion of various objects comprised in the video frame, in order to minimize temporal redundancy in the video signal. Intra prediction, spatial transformation, quantization, and AC/DC prediction, minimize spatial redundancy in the video signal. Rate control keeps the number of bits in compressed video (the rate) within a target rate, in order to operate within a constant data rate communication channel requirement, or alternatively in order to provide a constant or near constant video quality level independent of scene complexity. Entropy encoding usually comprises several operations, such as, and without limiting the generality of the foregoing, CABAC, CAVLC, and variable length coding, and is used to bring redundancy of an encoded video signal to minimal entropy levels. Bit-stream formatting creates a video bit-stream according to syntax requirements of suitable video compression standards.

The audio encoding unit (not shown) encodes uncompressed audio, thereby generating an audio bit-stream. The audio encoding unit comprises several components, such as, and without limiting the generality of the foregoing, a psycho-acoustic model component, a fast Fourier transform component, a filtering component, a quantization component, an entropy encoding component, and a bit-stream formatting component.

The multiplexer (not shown) multiplexes and formats video, audio, and other media and data streams, thereby producing one or more multiplexed streams. The multiplexed streams are preferably formatted in a suitable format. Suitable formats can be, by way of a non-limiting example, an MPEG2 transport stream, a program stream, as IP packets, as a packet format defined by Internet Streaming Media Alliance (ISMA) specifications, and other stream formats.

The multiplexed streams are usually transferred to the CA/DRM unit 121 for encryption before being transferred to an additional destination. The additional destination can be, by way of a non-limiting example, the hard disk 134, the remote STB, TV display, TV set, a mobile phone 410, the PMP 400, and the external storage unit 500 (not shown). The multiplexed streams are preferably transferred to the such destinations through a variety of communication interfaces and protocols, such as, by way of a non-limiting example, home networking, Multimedia over Coax Alliance (MOCA), home phone line networking (HomePNA), wireless communication, USB, eSATA, Ethernet, and so on.

In a preferred embodiment of the present invention, the encoder 126 continuously monitors transmission channels of the encoded media streams produced by the encoder 126, and evaluates available bandwidth. The encoder preferably employs rate control mechanisms which, based at least partly on results of the bandwidth evaluations, adjust the bit rate of the encoded streams, thereby enabling optimal use of the available bandwidth. Rate control methods capable of keeping video and audio bit-rates within specific rate targets are known in the art. Rate control algorithms capable of quickly changing video and audio bit-rate in accordance with specific rate targets are also known in the art.

In an alternative preferred embodiment of the present invention, when more than one stream is encoded and transmitted to remote STB and TV sets 300, the encoder 126 employs statistical multiplexing, dynamically assigning the available bandwidth to a number of media streams encoded and transmitted in parallel. Such statistical multiplexing is done, per media stream, in accordance with relative video scene complexity and additional parameters and is known in the art.

In yet another preferred embodiment of the present invention, streams received from a TV source are received having been encoded using an unconstrained variety of MPEG2 or AVC encoding options, utilizing techniques such as, by way of a non-limiting example, variable length Group Of Pictures (GOPs), reference B frames, multiple B frames between I and P frames, irregular I-frames, and so on. The encoded streams are optimized in terms of bit-rate and visual quality, but are unsuitable for personal video recorders, since they may not allow implementation of trick plays. The encoder 126 encodes uncompressed media streams using trick play enabling techniques, such as, by way of a non-limiting example, constant length and constant structure GOPs such as 15 frames GOPs structured as follows: I B B P B B P B B P B B P B B . . . ; frequent and constant insertion of I-frames such as one I-frame every half a second; and other techniques. The resulting media streams can be played back in time-shifting mode, can be stored to the hard disk 134 for personal video recording, and can be transmitted to the PMP 400 and client STB and TV set 300, where trick play support is typically a mandatory requirement.

In another preferred embodiment of the present invention, the encoder 126 encodes an uncompressed media stream in a form suitable for trick mode playback. The encoder 126 encodes the uncompressed media stream, by way of a non-limiting example, by encoding every second image, every third image, every fourth image, every tenth image, every fifteenth image, or some such like encoding, and skips encoding intermediate images. The encoder 126 thereby enables trick mode playback based on the resultant compressed video stream. It is to be appreciated that such trick mode encoding can be done simultaneously and in parallel with the regular encoding of every image.

In yet another preferred embodiment of the present invention, when uncompressed video comprises interlaced video, the display processor 124 de-interlaces the interlaced video before transferring de-interlaced video to the encoder 126. The encoder 126 encodes the de-interlaced video relieving a need to de-interlace the video after decoding and prior to playback.

In another preferred embodiment of the present invention, interlaced video is not de-interlaced by the display processor 124, and is encoded by the encoder 126 using interlaced video encoding techniques, such as, by way of a non-limiting example, picture adaptive field-frame encoding, or macroblock adaptive field frame encoding. When the compressed stream is decoded, it may be de-interlaced prior to playback.

It is to be appreciated that encoding de-interlaced video and bypassing de-interlacing prior to playback, rather than encoding interlaced video and de-interlacing prior to playback, may improve resulting video quality.

It is also to be appreciated that de-interlacing the uncompressed interlaced video prior to encoding also reduces the complexity of the encoder. Encoding of progressive video requires less computational resources and less complexity than encoding interlaced video. The reduction of complexity provides a reduction in silicon die size, in power, and in cost of the silicon die.

In yet another preferred embodiment of the present invention, the encoder 126 encodes uncompressed streams from the video and audio inputs 162, by way of a non limiting example, demodulated analog TV channels, preferably preprocessed by the pre-processor unit 127. The uncompressed streams from the video and audio inputs 162 are preferably de-interlaced, if need be, by the display processor 124.

The pre-processor 127 typically receives one or more video and audio signals from the audio and video inputs 162. The audio and video inputs 162 are typically connected to media sources which simultaneously transmit media streams.

In an alternative preferred embodiment of the present invention, the pre-processor 127 receives the video and audio signals from the secured storage unit 132.

The pre-processor 127 preferably comprises a digital input interface, a video ADC (not shown) and a video decoder (not shown) for converting analog video into digital form. The digital input interface is preferably according to a digital video standard, such as, by way of a non-limiting example, a CCIR656 interface, a digital video interface (DVI), an HDMI interface, and the like.

The video decoder (not shown) preferably comprises an analog front-end circuit, a synchronization circuit, a luma/chroma separation unit, a chroma demodulator, and a back-end circuit.

The pre-processor 127 preferably also has an array of filters. The filters are typically used for spatial and temporal filtering, preferably motion-compensated filtering, of received video signals. Additional signal processing, such as, by way of a non-limiting example, linear and nonlinear noise reduction, video resolution change (scaling), and frame rate conversion, are also preferably enabled.

The pre-processor 127 preferably has analysis capabilities, such as scene change detection, zoom in/out detection, fade-in/out detection, 3:2 and 2:2 pull-down detection and so on.

The preprocessed video signals produced by the pre-processor 127 are typically transmitted to the encoder 126. In an alternative preferred embodiment of the present invention, the preprocessed signals are also preferably transferred to the display processor 124, where the preprocessed signals are preferably de-interlaced, if need be, blended with graphics planes, data planes, still images and additional media streams, and played back through the video and audio outputs 161.

The CPU 130 provides computational power which is used to implement user applications, and to support and control different functional units of the transcoder set top box 100. The CPU 130 preferably supports application software such as DOCSIS Media Access Control (MAC), Out-of-Band (OOB) MAC, interactive gaming, Voice over IP (VoIP), video on demand (VOD), trick play support, DRM Key exchanges, DVD navigation, and so on.

It is to be appreciated that when the transcoder set top box 100 produces output supporting application software on remote client STBs and TV sets 300, there is a need for the transcoder set top box 100 to accept a remote user's interaction with the application software. Persons skilled in the art will appreciate that UHF remote controls are available which provide a range of communication which can extend, by way of a non-limiting example, from one room to another room in a home. Therefore a UHF remote control receiver (not shown) is comprised in the transcoder set top box 100, and connected to the CPU 130.

The CPU 130 receives external control signals comprising boot codes, interrupts, and software commands, from various sources. Typical sources are the secure storage 132, which is usually non-volatile flash memory or a read only memory, and the hard disk 134 (connection not shown). The CPU 130 preferably comprises a fast fixed point arithmetic logic unit, a floating point arithmetic unit, and an instruction and data cache.

Data transfer between the internal units of the transcoder set top box 100 and the secure storage unit 132 is preferably implemented via the secure memory controller 131. The internal units of the transcoder set top box 100 can transfer data, preferably simultaneously, to and from the secure storage 132 through the secure memory controller 131. The secure memory controller 131 manages a queue of data requests and memory accesses, and a queue of priorities assigned to each request and access. The memory controller 131 preferably comprises hardware dedicated to providing quality of service. The memory controller 131 preferably allocates memory space and bandwidth automatically, according to a suitable protocol used for managing communication with memory.

The secure memory controller 131 encrypts and decrypts data being transferred to and from the secure storage unit 132, in accordance with a variety of DRM schemes. Each memory address can preferably be assigned a different DRM key. The DRM keys are preferably not constant. The DRM keys are preferably kept in secure locations, such as, by way of a non-limiting example, the secured OTP, an external security devices such as a smart card, and so on, as described hereinabove.

In a preferred embodiment of the present invention, several secure keys are provided to the secure memory controller 131 by the CA/DRM unit 121.

In a preferred embodiment of the invention, the secure storage 132 is segmented in such a way that each internal unit of the transcoder set top box 100, and each authorized external device, may only access certain segments, while access to other segments is not allowed.

In a preferred embodiment of the present invention, the secure memory controller 131 tracks memory addresses being accessed by each internal unit of the transcoder set top box 100, and by authorized external devices, to make sure each internal unit or external device accesses only addresses the device is allowed to access. If an external device, or an internal unit of the transcoder set top box 100, makes an unauthorized access to an address, or to a segment of the secure storage 132, the access is blocked and a security breach warning is issued to the CA/DRM unit 121. The CA/DRM unit 121 is preferably suitably programmed to handle security breach warnings.

The secure storage 132 comprises volatile memory, for example Double Data Rate-2 (DDR2) memory. The size of such a DDR2 memory depends on application requirements, and can be up to 4 GByte and more.

In a preferred embodiment of the present invention, the secure storage 132 additionally comprises a non-volatile memory, by way of a non-limiting example NOR or NAND flash. The size of such non-volatile memory can vary from 8 MByte to 2 GByte and more.

The interface control unit 133 acts as a bridge, providing a secure connection between internal units of the transcoder set top box 100 and external devices. The external devices preferable comprise standard industry buses, electronic appliances, PMPs, remote Set top boxes and TV displays, wireless TV displays, mobile phones and other wireless devices, and so on.

The interface control unit 133 preferably supports glue-less connectivity to a variety of industry standard external busses 135, such as a Universal Serial Bus (USB), a peripheral component interconnect (PCI) bus, a PCI-express bus, an IEEE-1394 Firewire bus, an Ethernet and Giga-Ethernet (MII, GMII) bus, and so on.

The interface control unit 133 also preferably supports wireless communication standards such as, by way of a non-limiting example, IEEE 802.11(a), (b), (g), and (n) wireless LAN specifications, IEEE 802.16 WiMax, and so on.

The interface control unit 133 also preferably supports a glue-less connection to devices such as an external hard disk, preferably via an eSATA connector, an external DVD, a HD-DVD and a Blu-ray disk, via interfaces such as Advanced Technology Attachment (ATA) and Integrated Drive Electronics (IDE).

The interface control unit 133 also preferably supports connections to a home networking system, such as, by way of a non-limiting example, a MOCA connection, phone lines, and power lines.

The interface control unit 133 also preferably supports low speed peripheral interfaces, such as, by way of a non-limiting example, Universal Asynchronous Receiver/Transmitter (UART), Infra Red (IR), and plain telephone line.

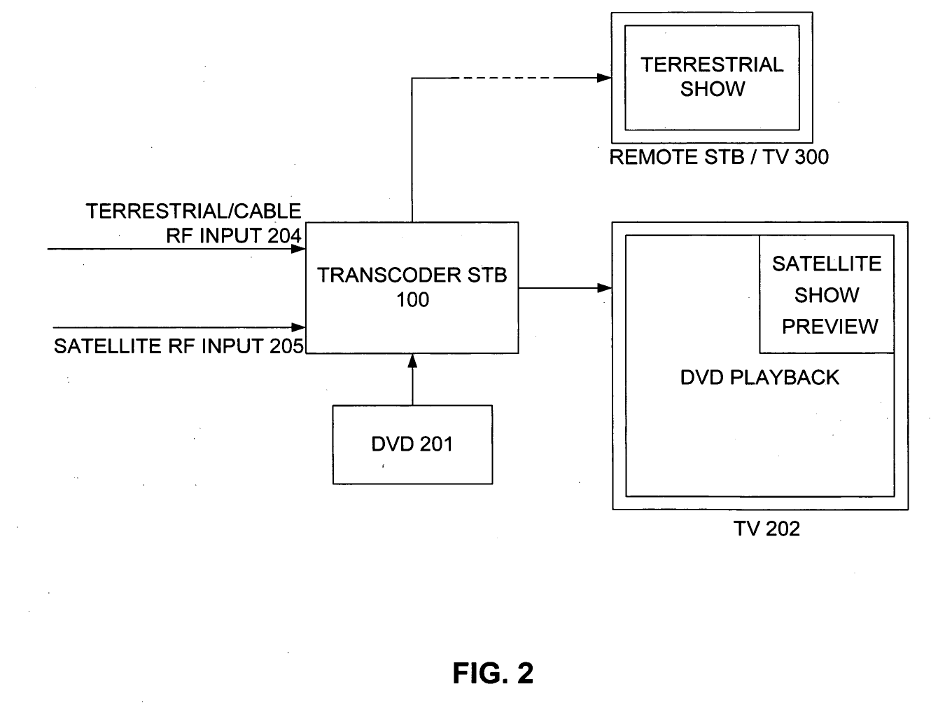

Reference is now made to FIG. 2, which is a simplified block diagram illustration of the transcoder set top box 100 of FIG. 1B being used in a first typical configuration.

The transcoder set top box 100 is connected to two RF inputs, a terrestrial/cable RF input 204, and a satellite RF input 205, to a DVD 201, to a remote client STB and TV set 300, and to a local television 202.

The transcoder set top box 100 in the first typical configuration operates as follows. The transcoder set top box 100 receives a number of TV channels via the terrestrial/cable RF input 204 and the satellite RF input 205 through the RF inputs 160 (FIG. 1B). The received TV channels are tuned, demodulated, decrypted, demultiplexed, decoded, and possibly blended with additional graphic and video planes, as described above with reference to FIG. 1B. The video and audio streams are further processed and preferably blended with additional media streams (as described below) by the display processor 124 (FIG. 1B) and transferred via the secure digital/analog output 125 (FIG. 1B) to the video and audio outputs 161 (FIG. 1B), and from there to the local television 202.

It is to be appreciated that the terrestrial/cable RF input 204 and the satellite RF input 205 are non-limiting examples, and that the inputs could include more RF inputs, and that the inputs could include, by way of a non-limiting example, cable input.

It is to be appreciated that the secure digital and analog output 125 (FIG. 1B) preferably formats the video and audio streams into a format suitable for the local television 202, such as, by way of a non-limiting example, analog S-video, composite video, component video, left/right stereo for audio, radio frequency modulated (RFM) video and audio, and digital HDMI for video, S/PDIF (Sony/Philips Digital Interface) for audio, including embedded VBI (Vertical Blanking Interval) signals and copy protection.

Simultaneously to the operation described above, additional media streams are transferred to the transcoder set top box 100 through the video and audio inputs 162 (FIG. 1B). The source of the additional media streams is a DVD 201. It is to be appreciated that the source of the additional media streams can be, by way of a non-limiting example, a video player, a DVD, an HD-DVD player, a Blu-ray player, a camcorder, a digital camera, and other Consumer Electronic (CE) appliances. The additional media streams are pre-processed as described with reference to FIG. 1B, preferably undergoing digital noise reduction, and further processed and preferably blended with the decoded media streams, as described above, by the display processor 124 (FIG. 1B) and transferred via the secure digital/analog output 125 (FIG. 1B) to the video and audio outputs 161 (FIG. 1B), and from there to the local television 202.

Simultaneously to the operation described above, the encoder 126 (FIG. 1B) encodes the composite video layout which preferably comprises decoded media streams, additional media streams, still images and graphics, as well as an associated audio signal, from the output of the display processor 124.

It is to be appreciated that the encoder 126 (FIG. 1B) may alternatively encode the preferably post-processed decoded media streams. It is also to be appreciated that the encoder 126 (FIG. 1B) may alternatively encode the preferably pre-processed additional media streams received directly from the preprocessor 127 (FIG. 1B). Such post-processing and such pre-processing preferably comprise noise reduction, frame rate conversion, and video scaling, to fit frame rate and resolution requirements of client devices such, by way of a non-limiting example, a remote client STB and TV set 300.

It is to be appreciated that if the decoded media streams or the additional media streams comprise interlaced video, the interlaced video may be de-interlaced by the display processor 124 prior to the encoder 126 performing the encoding.

It is to be appreciated that if the decoded media streams or the additional media streams comprise interlaced video, the interlaced video may be frame rate up-converted by the display processor 124, by way of a non-limiting example from 1080i to 1080p, prior to the encoder 126 performing the encoding.

It is to be appreciated that for applications requiring 1080p playback, frame rate up-conversion of the interlaced video prior to encoding, rather than frame rate up-conversion prior to playback, may improve video quality.

The video is encoded according to one or more advanced compression formats, such as, by way of a non-limiting example, MPEG2, MPEG4 part 10 (AVC), and VC-1. Associated audio is encoded according to one or more advanced compression formats, such as, by way of a non-limiting example, MPEG1 Layer II, AC-3, AAC, MP3, DTS etc. The encoder 126 multiplexes the video layout and the audio signal into one or more transport streams. The transport streams are preferably transferred to the CA/DRM unit 121 (FIG. 1B) where they are encrypted.

The encrypted transport streams are then sent to remote client STBs and TV sets 300. The encrypted transport streams can be delivered in a variety of ways, by way of a non-limiting example, by home networking connectivity such as MOCA, by HomePNA, by power line networking, by a wireless connection.

It is to be appreciated that the transport streams generated by the encoder 126 (FIG. 1B) and encrypted by the CA/DRM unit 121 (FIG. 1B) may optionally be stored on the hard disk 134 (FIG. 1B) for storage or for time-shifted playback.

In the first typical configuration presently described, the remote client STBs and TV sets 300 receive a composite media stream comprising of multiple video, graphics and data planes and still images, so that the remote STB and TV sets 300 need only be capable of supporting basic decoding and playback operations. The remote client STBs and TV sets 300 can operate without sophisticated software, without a high performance application CPU, without expensive storage such as a hard disk, without advanced graphics rendering, and without display processing, while still providing advanced services such as, by way of a non-limiting example, picture in picture, EPG, e-mail, internet access, voice over IP, Mosaic/Rich Navigation, time shifting, personal video recording, video on demand, video gaming and so on, as well as a high quality viewing experience.

In the first typical configuration presently described, the remote client STBs and TV sets 300 may be set top boxes and TV sets located in different rooms and locations in and about a customer's home and outside customer's home, such as in a hotel and in an office in a remote location, while a TV set in the living room may be the TV 202 connected to the transcoder set top box 100. Such a configuration allows all viewers around the house, as well as outdoor viewers, and not only the viewers located in the living room, access to all or most of the advanced services provided by the satellite or cable operator. The configuration of the entire home video network is simplified and significantly cost reduced.

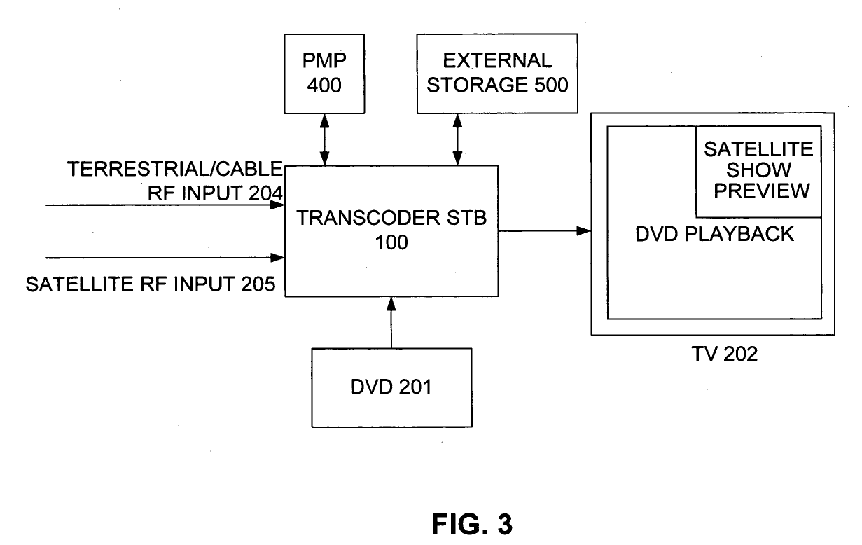

Reference is now made to FIG. 3 which is a simplified block diagram illustration of the transcoder set top box 100 of FIG. 1B being used in a second typical configuration.

The transcoder set top, box 100 is connected to two RF inputs, a terrestrial/cable RF input 204, and a satellite RF input 205, to a DVD 201, to a PMP 400, to external storage 500, and to a local television 202.

The inputs to the transcoder set top box 100 and the operation of the transcoder set top box 100 are substantially similar to the inputs to and operation of the transcoder set top box 100 in the first typical configuration described above.

The transcoder set top box 100 in the second typical configuration operates as follows. The transcoder set top box 100 receives a number of TV channels via the terrestrial/cable RF input 204 and the satellite RF input 205 through the RF inputs 160 (FIG. 1B). The received TV channels are tuned, demodulated, decrypted, demultiplexed, decoded, and possibly blended with additional graphic and video planes, as described above with reference to FIG. 1B. The video and audio streams are transferred, via the display processor 124 (FIG. 1B) and the secure digital/analog output 125 (FIG. 1B) to the video and audio outputs 161 (FIG. 1B), and from there to the local television 202.

Simultaneously to the operation described above, additional media streams are transferred to the transcoder set top box 100 through the video and audio inputs 162 (FIG. 1B). The additional media streams are pre-processed as described with reference to FIG. 1B, preferably undergoing digital noise reduction, and further processed and preferably blended with the decoded media streams by the display processor 124 (FIG. 1B) and transferred via the secure digital/analog output 125 (FIG. 1B) to the video and audio outputs 161 (FIG. 1B), and from there to the local television 202.

The transcoder set top box 100 also produces output suitable for the PMP 400. Within the transcoder set top box 100 a composite video signal is produced by the display processor 124 (FIG. 1B) and preferably undergoes de-interlacing, if need be, frame rate conversion and scaling to fit the frame rate and resolution requirements of the PMP 400. The PMP 400 is typically limited to standard definition, or even lower definition progressive video, while some of the TV streams received and decoded by the transcoder set top box 100 are high definition interlaced video signals. The PMP 400 is also typically limited to the frame rate of 30 frames per second or lower, while some of the TV streams received and decoded by the transcoder set top box 100 are received at a rate of 60 frames per second. A downscaling from the high definition video signals to a lower resolution, as well as de-interlacing and frame rate conversion are needed. Downscaling the TV streams from, by way of a non-limiting example, 1920×1080 at 30 frames/sec, or from 1280×720 at 60 frames/sec to 720×480 or 352×240 at 30 frames/sec or lower may be required. Frame dropping and other techniques may also be employed to reduce bit-rate. The downscaled, de-interlaced, and frame-rate converted streams are further encoded by the encoder 126 (FIG. 1B) and one or more transport streams are produced. It is to be appreciated that the encoded transport stream may comprise a composite layout including decoded streams, additional media streams, still images, and graphics. The encoded transport stream may also comprise decoded streams alone, additional media streams alone, and a combination thereof. The transport streams can be in different formats, such as, by way of a non-limiting example, ISMA (Intelligent Streaming Media Alliance) format, or ASF (Advanced Systems Format) introduced by Microsoft Corporation, and any other transport format, such as, by way of a non-limiting example, formats accepted by PMPs and mobile phones, all referred to herein as transport stream.

The resulting transport streams are preferably encrypted by the CA/DRM unit 121 (FIG. 1B) according to one of the digital right management schemes known in the art, by way of a non-limiting example a DRM10 scheme introduced by Microsoft Corporation.

The encrypted transport streams are further transferred outside the transcoder set top box 100 through the interface control unit 133 (FIG. 1B), and are further transferred to one or more PMPs 400 electronically attached, by wire or by wireless to the transcoder set top box 100. The transfer can be done in a variety of ways, by way of a non-limiting example, through a USB connection, an Internet connection, an IEEE1394 (Firewire) connection, and wirelessly through WiFi and WiMax connections, and so on.

A preferred embodiment of the present invention enables a viewer to upload a video program of choice to a portable player to view outdoors or at different time and location.

An issue of content protection and digital rights management is also addressed, by controlling information being uploaded to the PMP 400, and to a mobile phone 410 (FIG. 1B), by blocking unauthorized access, and by preserving security features embedded in the transport stream.

In a preferred embodiment of the present invention, the CA/DRM unit 121 (FIG. 1B) reads security information contained within one or more transport streams to be uploaded to the mobile phone 410 (FIG. 1B) or to the PMP 400, and operates in accordance with the security information embedded in the streams. By way of a non-limiting example, if the transport stream is marked so that viewing outside the transcoder set top box 100 is not allowed, transfer of the transport stream outside the transcoder set top box 100 will be blocked and an appropriate security message will be displayed. Preferably, the CA/DRM unit 121 (FIG. 1B) performs an authentication handshake procedure with the mobile phone 410 (FIG. 1B) or the PMP 400 and transfers to the mobile phone 410 or to the PMP 400 the security information embedded in the transport streams, in accordance to one or more digital rights management schemes. By way of a non-limiting example, if a media stream is marked as to allow a limited number of playbacks, or to expire after certain period of time, the security information is forwarded to the mobile phone 410 (FIG. 1B) or to the PMP 400.

It is to be appreciated that the transcoder set top box 100 also produces output suitable for the external storage 500. The original resolution of the received video stream is kept, or alternatively, the resolution of the received video stream may be up-scaled or down-scaled.

In an alternative use of the second typical configuration, content from one or more mobile phones 410 (FIG. 1B) or one or more PMP 400 or the external storage 500 can be uploaded to the transcoder set top box 100. The content can be stored in the HDD 134 (FIG. 1B), preferably after the content was decrypted and re-encrypted by the CA/DRM unit 121 (FIG. 1B) using a same or different CA/DRM protection scheme, for future use by the transcoder set top box 100. The content coming from the PMP 400 or the external storage 500 can also be decrypted by the CA/DRM unit 121 (FIG. 1B), decoded by the decoder 122 (FIG. 1B), processed by the display processor 124 (FIG. 1B), preferably blended with graphics, additional media streams, data displays, still images and so on, and output to the local television 202 through the more video and audio output 161 (FIG. 1B). A composite layout stream generated by the display processor 124 (FIG. 1B) can also be encoded by the encoder 126 (FIG. 1B) and transferred to the HDD 134 (FIG. 1B) or to another PMP 400 or the external storage 500, preferably after being encrypted by the CA/DRM unit 121 (FIG. 1B).

It is to be appreciated that the encoder 126 can re-encode streams received by the transcoder set top box 100 from the RF input 160 (FIG. 1B) into a form suitable for personal video recording applications and trick plays. The streams received from the RF input 160 (FIG. 1B) are often received encoded in a variety of unconstrained MPEG2 and AVC encoding options, utilizing techniques such as variable length GOPs, reference B-frames, multiple B-frames between I-frames and P-frames, irregular I-frames, and so on. The received streams are optimized in terms of bit-rate and visual quality, but may be unsuitable for personal video recorders. The received streams may not enable implementation of trick plays, which require constant GOP structure, frequent constant I-frame appearance, and so on. Re-encoding from the unconstrained formats into a trick play enabled format requires complete decoding to a level of uncompressed video and re-encoding from scratch taking into account limitations incurred by enabling trick play.

In typical configurations of preferred embodiments of the present invention, the transcoder set top box 100 operates as depicted in FIG. 2 and FIG. 3 and as described above, that is, receiving and decoding TV signals from multiple TV sources, preferably blending the decoded media streams with multiple graphics and data planes, still images and additional media streams received through the video and audio inputs 162 (FIG. 1B), preferably preprocessed by the preprocessor 127 (FIG. 1B) to generate a composite layout stream, preferably playing back the composite stream through the secure digital and analog output 125 (FIG. 1B) and the video and audio output 161 (FIG. 1B), and in parallel preferably de-interlacing and further encoding the composite stream, or individual streams, decoded or received from external electronic appliances, generating one or more transport streams, preferably encrypting such transport streams and transferring the transport streams in parallel and simultaneously to external remote STB clients and TV sets, as well as external storage devices, portable media players, and mobile phones electronically attached to the transcoder set top box 100, preferably performing security analysis of the media streams to be transferred to the portable player or the mobile phone, blocking unauthorized access and preserving and forwarding the security features of such media streams.

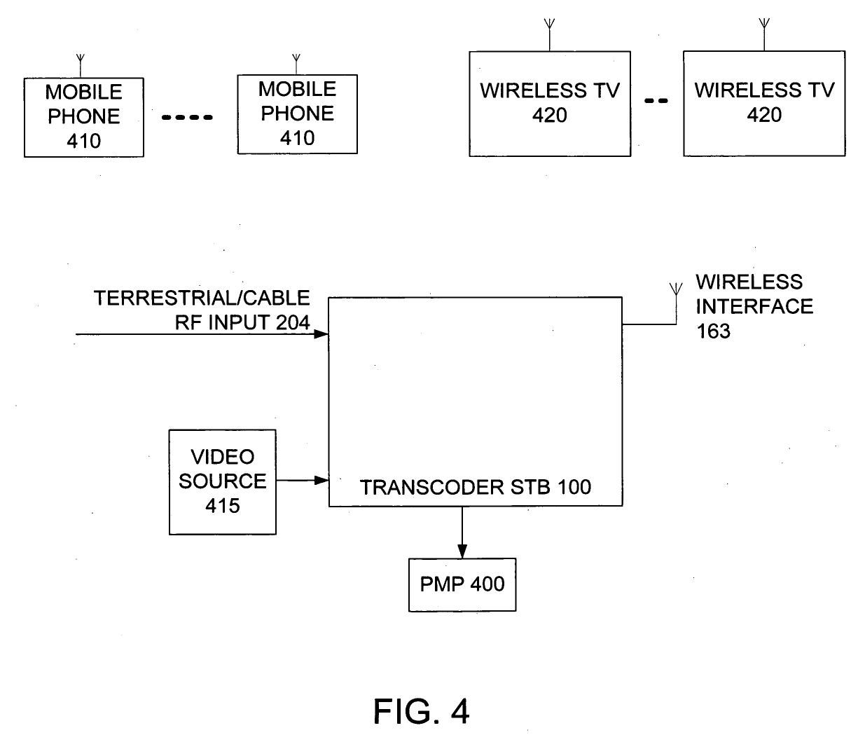

Reference is now made to FIG. 4, which is a simplified block diagram illustration of the transcoder set top box of FIG. 1B being used in a third typical configuration.

In FIG. 4, the transcoder set top box 100 is connected to two sources of input, the terrestrial/cable RF input 204, and a video source 415.

It is to be appreciated that the transcoder set top box 100 can be connected to three sources of input, as depicted in FIG. 3, or more sources of input. By way of a non-limiting example, the set top box 100 can be connected to a terrestrial signal feed through a terrestrial/cable RF input 204, a cable signal feed through another one of the terrestrial/cable RF inputs 204, and the video source 415.

It is to be appreciated that the video source can be a typical video source such as, by way of a non-limiting example, an HMS (Home Media Server), another set top box, a DVD player, a VCR, a camcorder, and so on.

The transcoder set top box 100 provides output to one or more mobile phones 410 and to one or more wireless TVs 420. The interface control unit 133 provides wireless transmission of the output, as described above with more detail with reference to FIG. 1B. The interface control unit 133 provides wireless communication via a wireless interface 163.

The transcoder set top box 100 also provides output to a PMP 400, as described above with more detail with reference to FIGS. 1B and 3.

The third typical configuration of FIG. 4 depicts a non-limiting example of a wireless TV system, also known in the art as “two piece TV” and “location-free TV”.

In the wireless TV system, a TV set is physically divided into two parts. A first part is a receiver, or a base station, being a device which receives TV signals, and possibly additional video streams. The base station preferably decrypts the TV signals and the video streams, producing decoded video streams. The base station also preferably generates graphics planes, and produces a combined layout display with one or more video planes, graphics and data planes, still images, and so on. The base station wirelessly transmits the combined layout display to a second part of the wireless TV system. The second part of the wireless TV system is a wireless TV display.

The transcoder set top box 100 acts as the base station in the third typical configuration depicted in FIG. 4.

Normally the base station is situated in a centralized location in a house, while the TV display may be freely moved around the house, without the need to connect the TV display to a video source with wires. A drawback of wireless TV systems is a high bandwidth required for transferring decoded TV signals wirelessly. By way of a non-limiting example, an HD channel may require effective bandwidth of more than 1.5 Gbps, or even more than 3 Gbps. Some cases, such as high definition over HDMI, can not be supported by existing wireless communication standards such as 802.11(a), (b), (g) or (n) or UWB (Ultra Wide Band).

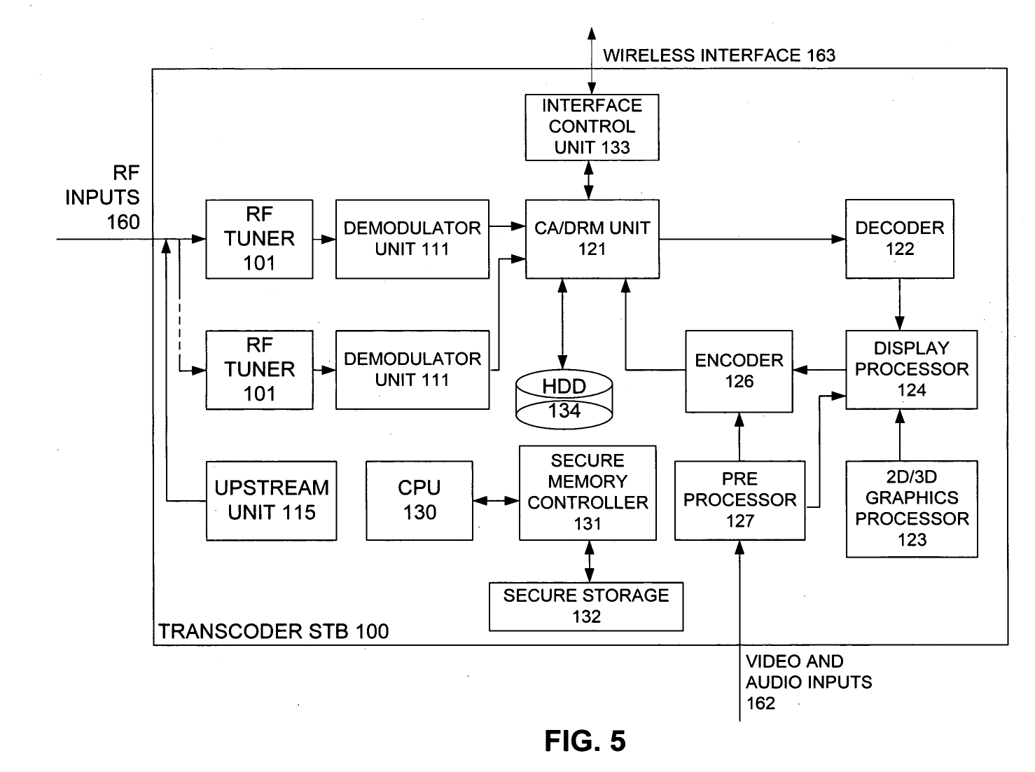

Reference is now made to FIG. 5, which is a simplified block diagram illustration of internal units within the transcoder set top box of FIG. 1B, arranged for better understanding of the transcoder set top box 100 being used in the third typical configuration.

The transcoder set top box 100 is used in the third typical configuration as a wireless TV base station in the sense described above with reference to FIG. 4.

The RF tuners 101, the demodulator units 111, the upstream unit 115, the CA/DRM unit 121, the decoder 122, the 2D/3D graphics processor 123, the display processor 124, the encoder 126, the pre-processor 127, the CPU 130, the secure memory controller 131, the secure storage 132, the interface control unit 133, the hard disk 134, the RF inputs 160, and the video and audio inputs 162, are connected and operate substantially as described above with reference to FIG. 1B.

It is to be appreciated that some units comprised in the transcoder set top box 100, such as, by way of a non-limiting example, the secure digital and analog output 125 and the video and audio outputs 161, are not depicted in FIG. 5 as they do not contribute to an understanding of the operation of the transcoder set top box 100 in the wireless TV base station configuration.

The wireless interface 163 is connected to the interface control unit 133 and provides wireless output, as described above with reference to FIG. 4.

The transcoder set top box 100 operates substantially as described above with reference to FIG. 1B. In the non-limiting example of the transcoder set top box 100 performing as a wireless TV base station, a combined display comprising one or more preferably de-interlaced video planes, graphics and data planes and still images is encoded, preferably in its original resolution, by the encoder 126, encrypted by the CA/DRM unit 121, and wirelessly transmitted to one or more wireless TV displays through the interface control unit 133 which operates as a wireless transmitter-receiver.

In an alternative preferred embodiment of the present invention, the combined display is encoded, formatted and transmitted to one or more mobile phones. When the receivers are mobile phones, the composite display is preferably scaled to a suitable resolution, such as, by way of a non-limiting example, CIF (Common Intermediate Format) or QCIF (Quarter CIF) resolution. The composite display is encoded using, by way of a non-limiting example, MPEG4 or AVC baseline profile compression schemes, to fit requirements and standards of mobile video communications.

Persons skilled in the art will appreciate that a transcoder enabled base station is highly advantageous when compared to other wireless base stations known in the art, such as, by way of a non-limiting example, described in U.S. Pat. No. 6,263,503. Encoding and transmitting the combined display combining multiple video planes, graphics planes, data planes, still images and so on enables a substantial reduction of TV display complexity and cost. The TV display requires only low cost decoder functionality, without expensive graphic capabilities, video enhancement capabilities, de-interlacing capabilities, display processing capabilities, an expensive application CPU, and so on. Additionally, the transcoder enabled base station not only requires substantially less bandwidth to transmit media streams, it also enables a great deal of flexibility in adjusting a broadcast rate of the media streams to a throughput of a transmission channel.

By way of a non-limiting example, when a prior-art wireless location-free TV is physically moved away from a prior-art base station, transmission will frequently interrupt, and eventually terminates as throughput of the wireless transmission channel decays. In a preferred embodiment of the present invention, the transcoder enabled set top box 100, operating as a base station, adjusts the transmission rate to the changing conditions of the wireless transmission channel, so that the transmission remains smooth and uninterrupted. The transmission is received at a somewhat decreased video quality, which is less annoying to a user than interruptions and termination of the transmission. The adjustment of the transmission rate is based, at least in part, on rate control capabilities of the encoder 126 and on the video scaling capabilities of the display processor 124.

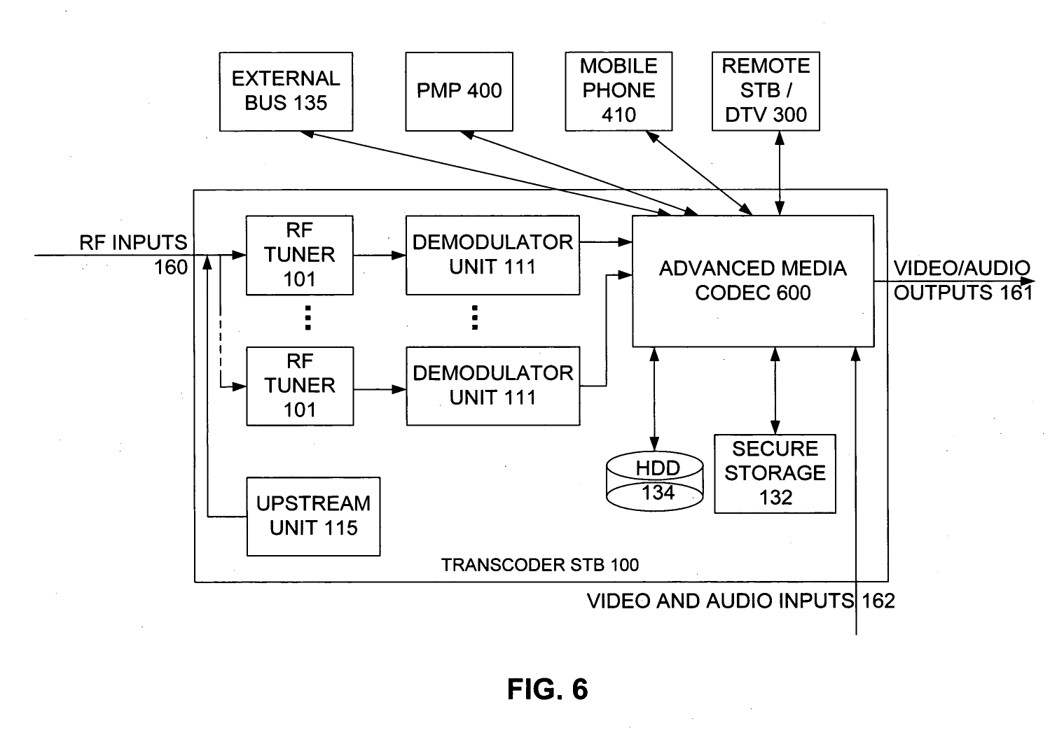

Reference is now made to FIG. 6, which is a simplified block diagram illustration of an alternative preferred embodiment of the present invention, based on an advanced media codec, being used in a fourth typical configuration.

In the alternative preferred embodiment of the present invention, substantially all of the transcoder set top box 100 functionality, except for storage and an RF front-end, is implemented in a single unit, for example by the media codec described in U.S. patent application Ser. No. 11/603,199 of Morad et al, the disclosure of which is hereby incorporated herein by reference. The single unit comprising the media codec is preferably comprised on a single piece of silicon.

The transcoder set top box 100 comprises:

one or more RF inputs 160;

one or more RF tuners 101, connected to the RF inputs 160;

one or more demodulator units 111, connected to the RF tuners 101;

an advanced media codec 600;

a secure storage 132, connected to the advance media codec 600;

a hard disk 134, connected to the advanced media codec 600;

one or more video and audio inputs 162, connected to the media codec 600;

one or more video and audio outputs 161, connected to the media codec 600; and

an upstream unit 115.

The third typical configuration depicts the transcoder set top box 100 connected to some typical connections, such as one or more mobile phones 410 or one or more PMPs 400, one or more remote client STBs and TV sets 300, and an external bus 135.

To implement the transcoder set top box 100 functionality, the media codec is operated in a decoder and transcoder mode, as described in U.S. patent application Ser. No. 11/603,199 of Morad et al.

Persons skilled in the art will appreciate that the functions performed by the CA/DRM unit 121, the decoder 122, the 2D/3D graphics processor 123, the display processor 124, the secure digital and analog output 125, the encoder 126, the pre-processor 127, the CPU 130, the secure memory controller 131, and the interface control unit 133 are performed by the advanced media codec 600.

The advanced media codec 600 performs all the functions which were attributed to the decoder 40, processor 60, and encoder 70 in FIG. 1A.

In an alternative preferred embodiment of the present invention, the advanced media codec 600 comprises the secure storage 132 within the packaging of the advanced media codec 600, on the single piece of silicon.

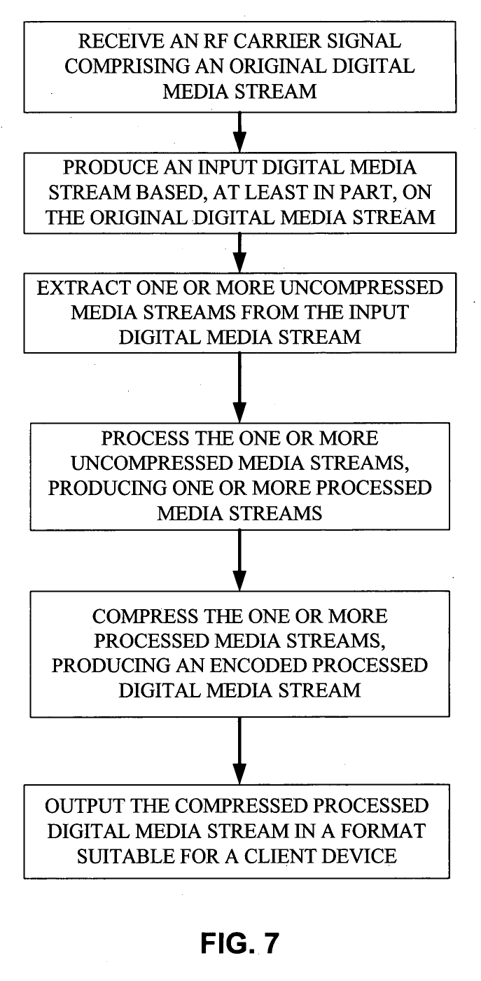

Reference is now made to FIG. 7, which is a simplified flowchart illustration of a preferred method of operation of the system of FIG. 1A. FIG. 7 is believed to be self-explanatory with reference to the above discussion of FIGS. 1A, 1B, 2, 3, 4, 5, and 6.

It is expected that during the life of this patent many relevant devices and systems will be developed and the scope of the terms herein, particularly of the terms “AV”, “AV stream”, “audio visual”, “audio visual stream”, “video”, “video stream”, “audio”, “audio stream”, “media”, “media stream”, “transport stream”, “TV signal”, “video signal”, “Mosaic”, and “Rich Navigation”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A media stream transcoding set top box (STB) comprising:
an RF input interface;
an RF receiver configured to receive from the RF input interface an RF signal comprising an original digital media stream, and produce an input digital media stream based, at least in part, on the original digital media stream, the input digital media stream comprising one or more channels, the channels carrying at least one media stream;
a decoder configured to receive the input digital media stream and extract therefrom an uncompressed media stream;
a processor configured to process the uncompressed media stream, to produce a processed media stream;
an encoder configured to compress the processed media stream, to produce a compressed processed digital media stream; and
an output interface configured to output the compressed processed digital media stream in a format suitable for a client device.

2. The STB according to claim 1 and wherein the compressed processed digital media stream is encrypted before being output.

3. The STB according to claim 1 and wherein the processor is configured to deinterlace the uncompressed media stream.

4. The STB according to claim 1 and wherein the output interface comprises a wireless communication interface.

5. The STB according to claim 1 and wherein the output interface comprises a wireless communication interface operative for wireless transmission and for wireless reception.

6. The STB according to claim 1 and wherein the output interface is also configured to output the processed media stream and to output the uncompressed media stream.

7. The STB according to claim 6 and wherein:
the RF input interface comprises a plurality of RF input interfaces;
the RF receiver is configured to simultaneously receive a plurality of RF signals and to simultaneously produce a plurality of input digital media streams;
the decoder is configured to simultaneously receive a plurality of input digital media streams, and to simultaneously extract therefrom more than one uncompressed media stream;
the processor is configured to simultaneously process more than one uncompressed media stream and to simultaneously produce more than one processed media stream;
the encoder is configured simultaneously compress more than one processed media stream and to simultaneously produce more than one compressed processed digital media stream;
the output interface comprises a plurality of output interfaces; and
the output interface is configured to simultaneously output more than one compressed processed digital media stream, more than one processed media stream, and more than one uncompressed media stream, via respective more than one output interfaces.

8. The STB according to claim 7 and wherein at least one of the more than one compressed processed digital media stream is encrypted before being output.

9. The STB according to claim 1 comprised in one integrated circuit.

10. The STB according to claim 1 and further comprising an input interface configured to receive the uncompressed media stream from an external source.

11. The STB according to claim 10 and wherein the input interface comprises a wireless communication interface.

12. The STB according to claim 10 and wherein the input interface comprises a plurality of input interfaces.

13. The STB according to claim 10 and wherein the processor is configured to receive uncompressed media streams simultaneously from the decoder and from the input interface.

14. The STB according to claim 10 and wherein the external source is one of a group of sources consisting of: a Local Area Network (LAN), a World Wide Web connection, a DVD player, a video player, an HD-DVD player, a Blu-ray player, a Portable Media Player (PMP), a mobile phone, a Consumer Electronic (CE) device, a camcorder, a digital camera, and a hard disk.

15. The STB according to claim 1 and wherein the processor is configured to modify the uncompressed media stream, and the encoder is configured to compress the modified processed media stream.

16. The STB according to claim 15 and wherein the modifying comprises changing a video resolution of the uncompressed media stream.

17. The STB according to claim 15 and wherein the modifying comprises de-interlacing the uncompressed media stream.

18. The STB according to claim 15 and wherein the modifying comprises changing a frame rate of the uncompressed media stream.

19. The STB according to claim 1 and wherein the encoder is configured to compress the processed media stream using a different compression standard than was used for the input digital media stream.

20. The STB according to claim 1 and wherein the encoder is configured to compress the processed media stream according to a compression standard based, at least in part, on a compression standard associated with the client device.

21. The STB according to claim 1 and wherein the processor is configured to process the uncompressed media stream to provide an advanced service for the client device, and wherein the advanced service is at least one of a group consisting of: EPG, e-mail, internet access, voice over IP, performing personal video recording, providing video on demand, and enabling video gaming.

22. The STB according to claim 1 and wherein the processor is configured to produce a processed media stream comprising a composite layout, the composite layout combining content of one of the uncompressed media streams with additional content.

23. The STB according to claim 22 and wherein the additional content comprises at least one of a still image, a graphic, and data.

24. The STB according to claim 1 and wherein the processor is configured to produce a processed media stream comprising a composite layout, the composite layout comprising content from two or more of the uncompressed media streams.

25. The STB according to claim 24 and wherein the composite layout is one of a group consisting of: a picture in picture comprised of content from the two or more uncompressed media streams, an EPG, and a mosaic comprised of content from more than one uncompressed media stream.

26. The STB according to claim 1 and wherein the client device is one of a group consisting of: a display device, a TV set, a TV display, a computer display, a set top box, an audio device, a home sound system, an audio-visual storage device, a mobile phone, a Portable Media Player (PMP), an MP3 player, and an MP4 player.

27. The STB according to claim 1 and wherein the encoder is configured to compress the processed media stream to comprise a bandwidth, based, at least in part, on a bandwidth associated with a transmission channel to the client device.

28. The STB according to claim 27 and wherein the encoder is configured to compress the processed media stream to comprise the bandwidth using rate control.

29. The STB according to claim 27 and wherein the encoder is configured to compress the processed media stream to comprise the bandwidth using statistical multiplexing.

30. The STB according to claim 27 and wherein the transmission channel is one of a group consisting of: a home network, a Local Area Network, a Wide Area Network, a wireless network, an optic fiber, and the Internet.

31. The STB according to claim 1 and wherein the encoder is configured to compress the processed media stream to comprise a bandwidth based, at least in part, on a bandwidth associated with the client device.

32. The STB according to claim 1 and wherein the encoder is configured to produce the compressed processed digital media stream to comprise DRM.

33. The STB according to claim 32 and wherein the DRM is based, at least in part, on DRM comprised in the input digital media stream.

34. The STB according to claim 32 and wherein the output interface is configured to output the compressed processed digital media stream only after performing an authentication handshake procedure with the client device.

35. The STB according to claim 32 and wherein the output interface is configured to block output of the compressed processed digital media stream based, at least in part, on DRM data comprised in the compressed processed digital media stream.

36. The STB according to claim 1 and wherein the encoder is configured to compress the processed media stream to produce a compressed processed digital media stream suitable for trick mode playback.

37. The STB according to claim 1 and wherein the encoder is configured to produce the compressed processed digital media stream in a manner suitable for trick mode playback, based, at least in part, on analysis performed by the processor.

38. The STB according to claim 37 and wherein the analysis comprises one of a group of analyses consisting of: scene change detection, zoom in/out detection, fade-in/out detection, 3:2 pull-down detection, and 2:2 pull-down detection.

39. A method of transcoding a media stream comprising:
receiving an RF signal comprising an original digital media stream;
producing an input digital media stream based, at least in part, on the original digital media stream, the input digital media stream comprising one or more channels, the channels carrying at least one media stream;
extracting an uncompressed media stream from the input digital media stream;
processing the uncompressed media stream, producing a processed media stream; and
compressing the processed media stream, producing a compressed processed digital media stream; and
outputting the compressed processed digital media stream in a format suitable for a client device.

40. The method according to claim 39 and wherein the outputting comprises wireless outputting.

41. The method according to claim 39 and wherein the outputting comprises encryption.

42. The method according to claim 39 and wherein the outputting additionally comprises outputting the processed media stream and outputting the uncompressed media stream.

43. The method according to claim 42 and wherein
the receiving comprises simultaneously receiving a plurality of RF signals;
the producing an input digital media stream comprises simultaneously producing a plurality of input digital media streams;
the extracting comprises simultaneously extracting a plurality of uncompressed media streams;
the processing comprises simultaneously processing a plurality of uncompressed media streams and simultaneously producing a plurality of processed media streams;
the compressing comprises simultaneously compressing a plurality of processed digital media streams and simultaneously producing a plurality of compressed processed digital media streams; and
the outputting comprises simultaneously outputting a plurality of processed media streams and compressed processed digital media streams to a plurality of respective client devices.

44. The method according to claim 39 and wherein the receiving further comprises receiving the input digital media stream from an external source.

45. The method according to claim 44 and wherein receiving comprises receiving the input digital media stream from an external source via wireless.

46. The method according to claim 44 and wherein the receiving the input digital media stream from an external source occurs simultaneously with producing an input digital media stream based, at least in part, on the original digital media stream.

47. The method according to claim 39 and wherein the processing comprises modifying the uncompressed media stream, and the compressing comprises compressing the modified uncompressed media stream.

48. The method according to claim 47 and wherein the modifying comprises at least one of a group consisting of: changing a video resolution of the uncompressed media stream, de-interlacing the uncompressed media stream, changing a frame rate of the uncompressed media stream, compressing the processed media stream in a trick-play friendly format, and compressing the processed media stream using a different compression standard than was used for the input digital media stream.

49. The method according to claim 39 and wherein the processing comprises processing the uncompressed media stream to provide an advanced service for the client device, and wherein the advanced service is at least one of a group consisting of: EPG, e-mail, internet access, voice over IP, performing personal video recording, providing video on demand, and enabling video gaming.

50. The method according to claim 39 and wherein the processing comprises producing the processed media stream to comprise a composite layout, the composite layout combining content of one of the uncompressed media streams with additional content.

51. The method according to claim 50 and wherein the additional content comprises at least one of a still image, a graphic, and data.

52. The method according to claim 39 and wherein the processing comprises producing the processed media stream to comprise a composite layout, the composite layout comprising content from two or more uncompressed media streams.

53. The method according to claim 52 and wherein the composite layout is one of a group consisting of: a picture in picture comprised of content from the two or more uncompressed media streams, an EPG, and a mosaic comprised of content from more than one uncompressed media stream.

54. The method according to claim 39 and wherein the compressing comprises compressing the processed media stream to comprise a bandwidth based, at least in part, on a bandwidth associated with a transmission channel to the client device.

55. The method according to claim 39 and wherein the compressing comprises compressing the processed media stream to comprise a bandwidth based, at least in part, on a bandwidth associated with the client device.

56. The method according to claim 39 and wherein the compressing comprises producing the compressed processed digital media stream to comprise DRM, based, at least in part, on DRM comprised in the input digital media stream.

57. The method according to claim 56 and wherein the outputting the compressed processed digital media stream is performed only after performing an authentication handshake procedure with the client device.

58. The method according to claim 39 and wherein the outputting is blocked based, at least in part, on DRM data associated with the compressed processed digital media stream.

59. The method according to claim 39 and wherein the compressing comprises producing the compressed processed digital media stream in a manner suitable for trick mode playback, based, at least in part, on analysis performed by the processing.
